(19) United States
(12) Patent Application Publication
(10) Pub. No.: US 2023/0384583 A1
(43) Pub. Date: Nov. 30, 2023

(54) OPTOELECTRONIC SYSTEM, LIDAR SYSTEM AND METHOD FOR CLEANING AN INTERIOR OF AN OPTOELECTRONIC SYSTEM

(71) Applicant: Robert Bosch GmbH, Stuttgart (DE)

(72) Inventors: Gabriel Cichon, Ludwigsburg (DE); Michael Zoeller, Beilstein (DE)

(21) Appl. No.: 18/247,632

(22) PCT Filed: Sep. 28, 2021
(86) PCT No.: PCT/EP2021/076564

§ 371 Date: Mar. 31, 2023

(30) Foreign Application Priority Data
Oct. 19, 2020 (DE) 10 2020 213 162.7

(51) Int. Cl. G02B 27/00; B08B 6/00; G01S 7/481

(52) U.S. Cl. CPC G02B 27/0006; B08B 6/00; G01S 7/4811

(57) ABSTRACT

An optoelectronic system which has a vacant interior. The optoelectronic system has a soiling collector which is arranged in the interior and is designed to attract soiling which may be present in the interior and retain it on itself, so as to concentrate the soiling present in the interior on the soiling collector. A lidar system which comprises such an optoelectronic system, and a corresponding method for cleaning the interior of the optoelectronic system, are also described.

### FIELD

The present invention relates to an optoelectronic system having a vacant interior.

The present invention further relates to a lidar system comprising such an optoelectronic system.

The present invention further relates to a method for cleaning the interior of an optoelectronic system.

### BACKGROUND INFORMATION

Stringent cleanliness requirements apply to many products, including optoelectronic sensors. In addition to metallic and non-metallic particles, dust fibers are also extremely critical, as they lead to “blind spots”. In addition to a precise definition of the component/assembly cleanliness or residual soiling (for example test method to ISO 16232-3), stringent requirements are placed on cleanliness during mounting of the sensor. Nonetheless, low levels of contamination may arise, which may have a negative effect on functioning or lead to complete failure.

U.S. Patent Application Publication No. US 2015/036037 describes a camera system having a self-cleaning lens. The camera system has a charge generator which can generate a positive or a negative electrical charge and apply the generated electrical charge to the surface of the camera lens. In this way, charged particles, such as for instance dust, can be removed from the camera lens, after such particles have accumulated.

Despite the above-stated measures, the presence of particles or fibers inside the sensors cannot be ruled out. An added complication is that fibers have a significantly greater negative impact in optical sensors than in purely mechanical products. A critical factor here is that particles or fibers may change position over time (e.g., due to drafts, vibration, etc.) and thus cannot be 100% identified by testing at the and of a production line. In addition, lightly adhering particles may become detached in a product over its service life. Due to the aperture angle of optical sensors, even ultra-small particles on a lens, a receiver chip of an opto-receiver and the like can cause significant “blind spots”. The consequence may be field failure (for example complete failure or reduced performance).

### SUMMARY

The present invention provides an optoelectronic system having a vacant interior. According to an example embodiment of the present invention, the optoelectronic system has a soiling collector which is arranged in the interior and is designed to attract soiling which may be present in the interior and retain it on itself, so as to concentrate the soiling present in the interior on the soiling collector.

The optoelectronic system of the present invention may have the advantage that soiling which may be present in the interior thereof can be concentrated in regions of the interior which are less important to functioning of the system, so as to ensure durably reliable functioning of the system, which would be jeopardized if the soiling were present or even concentrated in other regions of the interior of greater importance to functioning of the system. Thus, soiling-related failure of the optoelectronic system can be prevented or at least delayed, so increasing the reliability of the optoelectronic system.

For the purposes of the present application, the expression “vacant interior” may be understood to mean that the interior constitutes a free space which may be partly filled by components of the optoelectronic system, i.e., it need not necessarily be completely empty. The vacant interior is thus in particular vacant because portions thereof are not filled with components of the system. It is particularly preferable for the vacant interior to be of continuous configuration, i.e. to be a single contiguous vacant interior. In this case, a single soiling collector may suffice for the entire interior.

Soiling may in particular be airborne suspended materials in the interior. Dust particles and dust fibers may preferably be soiling, which may be metallic or non-metallic. Such types of soiling in the interior may be particularly troublesome for operation of the optoelectronic system and therefore concentrating them on a soiling collector may be particularly advantageous.

The optoelectronic system may preferably be part of a lidar system. The lidar system should have a particularly clean interior if it is to be able to function perfectly. “Blind spots” caused by soiling on the opto-transmitter or the opto-receiver or a field failure caused thereby may thus be prevented. A preferred lidar system is an automotive lidar system, which may be part of a motor vehicle. The lidar system is particularly preferably designed to receive depth information about an environment of the lidar system. Alternatively, the optoelectronic system may however also be part of other sensor systems or other products which have elevated cleanliness requirements.

According to an example embodiment of the present invention, the optoelectronic system preferably has optically active elements, in particular lenses and/or mirrors. The soiling collector is particularly preferably not such an optically active element, i.e., in particular not a lens and/or mirror, of the optoelectronic system, but rather is a supplementary device which is provided in addition to lenses and mirrors. The lenses and mirrors may thus be kept free of soiling and carry out their optical function while the soiling collector attracts the soiling and retains it on itself.

The soiling collector is preferably designed to attract the soiling using Coulomb force. Coulomb force is a long-known physical force between electrically charged objects. Objects having electrical charges of the same sign repel one another, while objects having electrical charges of the same sign attract one another. This principle can preferably be utilized to attract the soiling to the soiling collector and retain it there.

According to an example embodiment of the present invention, the soiling collector preferably has one or more soiling collection units, which are designed to be electrically charged. A soiling collection unit may preferably have a negative electrical charge. A soiling collection unit may preferably have a positive electrical charge. The Coulomb force may accordingly be used particularly effectively to move soiling which has a negative charge to the positively charged soiling collection unit or indeed to move soiling which has a positive charge to the negatively charged soiling collection unit. The Coulomb force may preferably move the soiling through the vacant interior to the soiling collection unit, such that additional forces which might have to be generated to move the soiling become superfluous. Preferred soiling collection units are made of metal.

According to an example embodiment of the present invention, the soiling collector preferably comprises a first soiling collection unit and a second soiling collection unit. The first soiling collection unit is particularly preferably designed to be charged with an opposite electrical charge to the second soiling collection unit. The first soiling collection unit may preferably have a positive electrical charge and the second soiling collection unit a negative electrical charge. In this way, soiling with a positive electrical charge and soiling with a negative electrical charge may be attracted equally well by the soiling collector. In some embodiments, it is also possible to provide multiple first collection units with a positive electrical charge or indeed multiple second collection units with a negative electrical charge. This can further improve collecting performance.

In some example embodiments of the present invention, provision is made for the soiling collector to be arranged on a bottom of the interior. Gravity can then be used as a naturally present force to improve further the action of the soiling collector. Accordingly, when the optoelectronic system is in the operating state, a normal vector to the bottom of the interior, which is perpendicular to the bottom, preferably runs parallel to the direction of action of gravity.

Some embodiments of the present invention make provision for the soiling collector to be arranged in a region of the interior which is arranged to be flowed through by an airflow. The airflow may in particular be actively producible by a fan, which is provided in the optoelectronic system. This may further improve the transfer of soiling to the soiling collector. Alternatively, a natural airflow may be provided, which is conveyed passively into the interior through one or more ventilation slots, for example airflow caused by a headwind. In this way, electrical power is saved.

The optoelectronic system of an example embodiment of the present invention preferably has an opto-transmitter and an opto-receiver in the interior. It is particularly preferable for the soiling collector to be arranged closer to the opto-transmitter than to the opto-receiver. It is often important to keep the opto-transmitter in particular free of soiling. The arrangement proposed as preferable means that the soiling collector has a greater effect on the region of the interior in the vicinity of the opto-transmitter. The opto-transmitter may be a laser source. The opto-receiver may be a photodetector and in particular comprise a photodiode and/or a photosensitive receiver chip.

It is preferable for the interior to be surrounded by a housing. This enables the vacant interior to be simply provided and delimited. The housing may be a plastics housing or a metal housing. The housing is preferably sealed relative to the outside, to hinder or prevent soiling from penetrating into the interior. It is thus also preferable for the housing to be hermetically sealed relative to the outside. In some embodiments, however, the housing may, as mentioned above, have one or more ventilation slots in order in particular to admit head wind into the housing. The ventilation slots may then preferably contain a filter to lessen penetration of soiling into the housing.

According to one example embodiment of the present invention, a lidar system is further provided which comprises such an optoelectronic system.

According to an example embodiment of the present invention, the lidar system comprising such an optoelectronic system in one embodiment has the advantage that soiling which may be present in the interior thereof can be concentrated in regions of the interior which are less important to functioning of the system, so as to ensure durably reliable functioning of the system, which would be jeopardized if the soiling were present or even concentrated in other regions of the interior of greater importance to functioning of the system. Thus, soiling-related failure of the lidar system can be prevented or at least delayed, so increasing the reliability of the lidar system.

Possible advantageous embodiments of the lidar system of the present invention are revealed by the above explanations of possible embodiments of the optoelectronic system and the advantages thereof, to which explicit reference is made in order to avoid repetition.

According to the present invention, a method is further provided for cleaning the interior of an optoelectronic system which comprises the step of:
providing a soiling collector in the interior in order to concentrate soiling which may be present in the interior on the soiling collector.

The method of the present invention may have the advantage that soiling which may be present in the interior thereof can be concentrated in regions of the interior which are less important to functioning of the system, so as to ensure durably reliable functioning of the system, which would be jeopardized if the soiling were present or even concentrated in other regions of the interior of greater importance to functioning of the system. Thus, soiling-related failure of the optoelectronic system can be prevented or at least delayed, so increasing the reliability of the optoelectronic system.

According to an example embodiment of the present invention, the method firstly comprises the step of providing an optoelectronic system with an interior. The method preferably comprises the step of electrically charging one or more soiling collection units of the soiling collector to attract oppositely charged soiling which may be present in the interior and concentrate it on the soiling collection unit.

According to an example embodiment of the present invention, the method preferably comprises the step of electrically charging a first soiling collection unit of the soiling collector with a first electrical charge and electrically charging a second soiling collection unit of the soiling collector with a second electrical charge, which is of opposite polarity to the first electrical charge, in order in each case to attract electrically oppositely charged soiling which may be present in the interior and concentrate it on the respective soiling collection unit.

It is preferable for the method of the present invention to comprise the step of passing an airflow past the soiling collector. The airflow preferably passes through the interior and in this way feeds soiling mechanically to the soiling collector, in addition to any electrical Coulomb force that may be acting between soiling and soiling collector. This may further improve the soiling collection action at the soiling collector.

Further possible method steps can be derived from the above explanations of possible embodiments of the optoelectronic system of the present invention and the advantages thereof, to which explicit reference is made in order to avoid repetition.

Advantageous configurations of the present invention are disclosed herein.

### BRIEF DESCRIPTION OF THE DRAWINGS

Exemplary embodiments of the present invention are explained in greater detail with reference to the figures and the following description.

FIG. 1 shows a first embodiment according to the present invention.

FIG. 2 shows a second embodiment according to the present invention.

FIG. 3 shows a diagram of a method according to the present invention.

### DETAILED DESCRIPTION OF EXAMPLE EMBODIMENTS

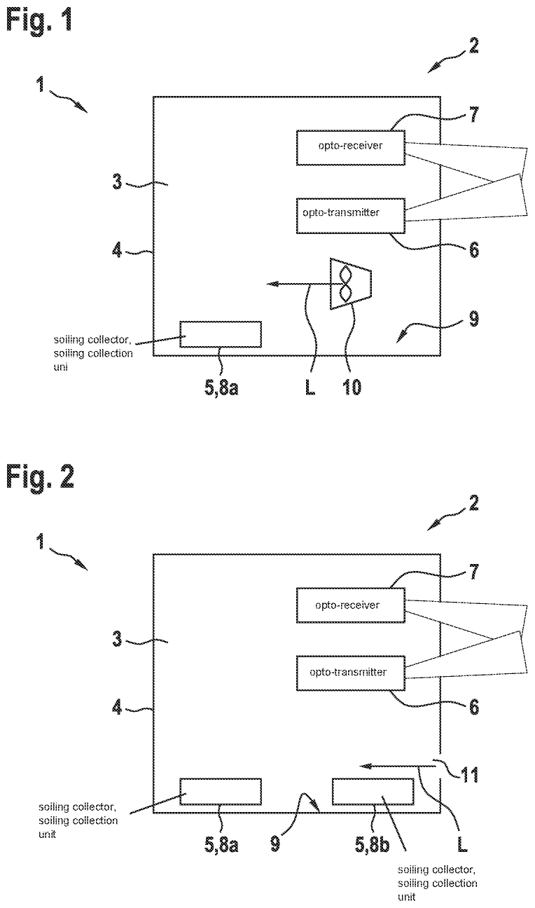

FIG. 1 shows an optoelectronic system 1 according to a first embodiment of the present invention. A lidar system 2, as may be used for instance in motor vehicles, comprises the optoelectronic system 1. The optoelectronic system 1 has a vacant interior 3. The interior 3 is surrounded by a housing 4.

The housing 4 defines the vacant interior 3. The housing 4 is the housing 4 of the optoelectronic system 1.

The optoelectronic system 1 has a soiling collector 5. The soiling collector 5 is arranged in the interior 3. An opto-transmitter 6, here by way of example a laser emitter, and an opto-receiver 7, here by way of example a photodetector, are likewise arranged in the interior 3. The opto-transmitter 6 is designed to emit a beam of light into an environment of the lidar system 2. The opto-receiver 7 is designed to receive the beam of light reflected in the environment. On the basis of the transit time of the light beam, the lidar system 2 can then in particular obtain depth information about the environment.

The soiling collector 5 is designed to attract soiling which may be present in the interior 3 and retain it on itself, in order to concentrate the soiling in the interior 3 on the soiling collector 5. In this way, the soiling may be kept away from the opto-transmitter 6 and from the opto-receiver 7, so increasing the reliability of the optoelectronic system 1.

The soiling collector 5 is designed to attract the soiling using Coulomb force. To this end, the soiling collector 5 has a soiling collection unit 8a, which is designed to be electrically charged. To this end, the optoelectronic system 1 comprises a voltage source (not shown), which is electrically connected with the soiling collection unit 8a in order to electrically charge the soiling collection unit 8a. The soiling collection unit 8a may be either positively or negatively charged. In the present case in FIG. 1, the soiling collection unit 8a is positively charged.

The soiling collector 5 is arranged on a bottom 9 of the interior 3 so that, in addition to the Coulomb force, gravity is also used to guide soiling to the soiling collector 5.

The soiling collector 5 is furthermore arranged in a region of the interior 3 which is arranged to be flowed through by an airflow L. The interior 3 has a fan 10 for passing the airflow L past the soiling collector 5. In this way, a mechanical conveying force is also used to guide soiling to the soiling collector 5. The arrow indicates schematically the main direction of movement of the airflow L, as brought about by the fan 10.

The soiling collector 5 is arranged closer to the opto-transmitter 6 than to the opto-receiver 7. The Coulomb force, which is exerted on soiling by the soiling collector 5, is thus greater at the opto-transmitter 6 than at the opto-receiver 7, and so the cleaning action is greater in the region of the opto-transmitter 6 than at the opto-receiver 7, a situation which may be advantageous.

FIG. 2 shows a second embodiment according to the present invention. The soiling collector 5 here comprises a first soiling collection unit 8a and a second soiling collection unit 8b. The first soiling collection unit 8a is designed to be charged with an opposite electrical charge to the second soiling collection unit 8b. To this end, the two soiling collection units 8a, 8b are connected to the voltage source (not shown), which can provide both a negative and a positive charge. For instance, the first soiling collection unit 8a is designed to be electrically positively charged and the second soiling collection unit 8b is designed to be electrically negatively charged. Thus, in this embodiment, both negatively charged soiling and positively charged soiling can be attracted by the respective soiling collection unit 8a, 8b of the soiling collector 5 having the opposite electrical charge to the corresponding soiling.

In the second embodiment too, the soiling collector 5 is arranged in a region of the interior 3 which is arranged to be flowed through by an airflow L. However, according to FIG. 2, provision is made for a ventilation slot 11 to be provided in the housing 4 instead of the fan 10, so enabling passive ventilation by head wind. A filter (not shown) may be provided in the ventilation slot 11 to lessen the penetration of soiling into the housing 4. The other features of the second embodiment are similar to those in FIG. 1, and therefore repetition will be dispensed with at this point.

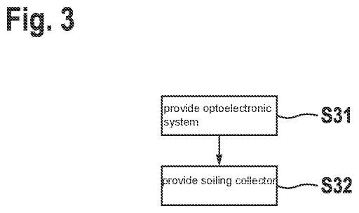

FIG. 3 is a schematic representation of a method in an embodiment according to the present invention. Said method comprises the step S31 of providing an optoelectronic system 1 comprising an interior 3. The subsequent step S32 involves providing a soiling collector 5 in the interior 3 in order to concentrate soiling which may be present in the interior 3 on the soiling collector 5. Possible further steps or substeps can be derived from the above general description and in particular from the detailed description relating to FIGS. 1 and 2.

In the embodiments shown, the present invention thus in other words provides a targeted collection point, namely the soiling collector 5, for particles and fibers which are present inside the sensor. This is achieved in particular in that, inside the sensor, i.e. in the interior 3, a positively and/or a negatively charged zone is provided by means of the first soiling collection unit 8a and/or the second soiling collection unit 8b. Particles or fibers which may be negatively or positively charged inter alia by air movement are guided into the corresponding zone 8a, 8b by the Coulomb force (force of attraction) and adhered there. This effect may, for example, also be observed with screen monitors, TV screens and the like. Ideally, as shown, the collecting zones, i.e. the soiling collection units 8a, 8b, are positioned such they can be optimally reached by the preferred soiling, i.e. particles or fibers. This is the case, for example, if said zones are at the bottom 9 (utilization of gravity) or for example in the region of an airflow L. The present invention may in particular, as shown, be used in lidar systems 2, but optionally in other exemplary embodiments also in further sensor systems or products which have elevated cleanliness requirements.

Although the present invention has been illustrated and described in greater detail with reference to preferred exemplary embodiments, the present invention is not limited by the disclosed examples and other variations may be derived therefrom by a person skilled in the art without going beyond the scope of protection of the present invention.

1-10. (canceled)

11. An optoelectronic system having a vacant interior, the optoelectronic system comprising:
a soiling collector which is arranged in the interior and is configured to attract soiling which may be present in the interior and retain the soiling on itself, so as to concentrate the soiling present in the interior on the soiling collector.

12. The optoelectronic system as recited in claim 11, wherein the soiling collector is configured to attract the soiling using Coulomb force.

13. The optoelectronic system as recited in claim 11, wherein the soiling collector has one or more soiling collection units which are configured to be electrically charged.

14. The optoelectronic system as recited in claim 13, wherein the soiling collector includes a first soiling collection unit and a second soiling collection unit and the first soiling collection unit is configured to be charged with an opposite electrical charge to the second soiling collection unit.

15. The optoelectronic system as recited in claim 13, wherein the soiling collector is arranged on a bottom of the interior.

16. The optoelectronic system as recited in claim 11, wherein the soiling collector is arranged in a region of the interior which is arranged to be flowed through by an airflow.

17. The optoelectronic system as recited in claim 11, further comprising:
an opto-transmitter and an opto-receiver in the interior, wherein the soiling collector is arranged closer to the opto-transmitter than to the opto-receiver.

18. The optoelectronic system as recited in claim 11, wherein the interior is surrounded by a housing.

19. A lidar system, comprising:
an optoelectronic system having a vacant interior, the optoelectronic system comprising:
a soiling collector which is arranged in the interior and is configured to attract soiling which may be present in the interior and retain the soiling on itself, so as to concentrate the soiling present in the interior on the soiling collector.

20. A method for cleaning an interior of an optoelectronic system, comprising the following:
providing a soiling collector in the interior to concentrate soiling which may be present in the interior on the soiling collector.
